(19) United States
(12) Patent Application Publication
(10) Pub. No.: US 2001/0033486 A1
(43) Pub. Date: Oct. 25, 2001

(54) Non-shadow multi-position lighted instrument holder

(76) Inventor: Steven M. Maine, Parma, ID (US)

Correspondence Address: David Jacobsen, 102 E. Tucker Ave., Parma, ID, 83660, US

(21) Appl. No.: 09/788,096

(22) Filed: Feb. 20, 2001

Related U.S. Application Data
(60) Provisional application No. 60/184,133, filed on Feb. 22, 2000.

(51) Int. Cl. B25B 23/18

(52) U.S. Cl. 362/119; 362/109; 362/191; 362/208

(57) ABSTRACT

The device comprises a pistol shaped “grip” designed to ergonomically rest in the user's Palm. Illumination means at a superior portion of the grip and a multi-position docking mechanism for incorporating various instruments at various user defined locations along the grip's vertical axis. The assembly is configured to allow the user, with one hand, to illuminate the work area and use an instrument without substantially obstructing the light source.

### CROSS-REFERENCE TO RELATED APPLICATIONS

This application refers back to provisional application Ser. No. 60/184,133 Filling date Feb. 22, 2000.

### FEDERALLY SPONSORED RESEARCH OR DEVELOPMENT

Not Applicable

### REFERENCE TO A MICROFICHE APPENDIX

Not Applicable

### BACKGROUND TO THE INVENTION

1. Field of the Invention

The invention relates to lighted hand-held instruments including: tweezers, forceps screwdrivers, pliers, wire cutters, magnifying lenses, seam rippers, ratchet assemblies and hole augers.

2. Description of Related Art

Performing work in dim or obscure lighting often requires specialized lighting, a flashlight or lantern. This requirement compromises safety and performance when a worker must hold the lighting fixture for better viewing in limited space environments.

Many devices address these issues by attempting to provide convenient illumination means including: Neugass (U.S. Pat. No. 2,376,448), Zuckerman (U.S. Pat. No. 2,666,843), Johnson (U.S. Pat. D175,259), Spedding (U.S. Pat. No. 3,287,547) and Nalbandian (U.S. Pat. D253,974). These variations of similarly designed illuminated tweezers depict illumination means between the tweezer's prongs. The grasped area shadows when squeezing the tweezer s prongs making it difficult to view work in progress.

Cooper (U.S. Pat. No. 4,302,797) illustrates HAND TOOLS (in screwdriver form) comprising a hollowed shaft with fiber optic cables, a light bulb in the handle and a blade at the insertion point. Light passes through the blade and illuminates the area where the blade inserts into the screw head. The fiber optic lines focus light on the screw head and provide limited work area illumination.

Holoff, deceased et al. (U.S. Pat. No. 4,524,647) describes a lighted TWEEZER ASSEMBLY with a magnified viewing lens. The user wraps their palm around the device and pinches the tweezers. The magnification lens provides a functional viewing area commensurate with vertical or horizontal clearance between the user's eye(s) and the device.

Hoskin, et al. (U.S. Pat. No. 4,671,283) is a FORCEPS with a groove running along the inner face of each arm that contains fiber optic cable for tip illumination. Hoskin, et al. limits viewable area akin to Cooper wherein the cone of illumination focuses upon the actual grasping point.

Owen (U.S. Pat. No. 4,836,596) combines TWEEZERS AND MAGNIFIER wherein the parts snap together to provide efficient assembly and sterilization. The device provides no artificial illumination.

Finn, et al. (U.S. Pat. No. 5,667,473) depicts an elaborate SURGICAL INSTRUMENT AND METHOD FOR USE WITH A VIEWING SYSTEM for endoscopic surgery. This Device employs fiber optics that couple to an auxiliary viewing system. The elongated and complex device requires a monitor for visualization.

The present invention addresses these ergonomic and illumination issues with a pistol shaped grip and overhead illumination to cast unrestricted light upon a chosen work area. For example, a user may choose tweezers to pluck eyebrows or remove splinters without shadow hindrance.

The device also provides a multi-position docking feature to accommodate several types of tools ranging from forceps and screwdrivers to seam rippers and surgical instruments. This versatility translates into reduced manufacturing costs and environmental waste while improving safety and performance.

### BRIEF SUMMARY OF THE INVENTION

The device comprises a pistol shaped “grip” designed to ergonomically rest in the user's palm, illumination means at a superior portion of the grip and a multi-position docking mechanism for incorporating various instruments at various user defined locations along the grip's vertical axis.

### BRIEF DESCRIPTION OF THE DRAWINGS

The figures depict several, but not all, embodiments of the NON-SHADOW MULTI-POSITION LIGHTED INSTRUMENT HOLDER.

FIG. 1 is a left side view of one device embodiment.

FIG. 2A is a right side view of one device embodiment incorporating tweezers in a position in which the tweezer tip is close to the light bulb and generally aligned with the longitudinal axis of the light.

FIG. 2B is a right side view of the embodiment of FIG. 2A with the tweezers in a position in which the tweezer tip is farther from the light bulb and generally aligned with the longitudinal axis of the light.

FIG. 3 is a side view of one device embodiment incorporating a seam ripper.

### DETAILED DESCRIPTION OF THE INVENTION

Referring to the Figures: Instrument holder (2) comprises grip (4), lighting (6) and multi-position invention docking system (8).

Grip's (4) ergonomic design permits comfortable placement between the thumb and fingers of a clenched fist. Its construction may utilize metals, non-metals or composite materials in whole or part. A preferred grip embodiment utilizes injection molding to form a single piece grip wherein ridges (10, 10′, 10″) ergonomically fit between the user's fingers and a recess (12) accommodates the extension of palm body mass between the thumb and wrist. The grip preferably has an elongated member with broad side surfaces (23 and 23′) and relatively narrow front (27) and rear surfaces (29), with smoothed or rounded corners. Front surface (27) may curve concavely for fingers and thumb to meet and grasp the grip (middle, ring and little finger) while thumb and index finger grasp and work the tool. Rear surface (29) may curve convexly to comfortably fit against the palm regardless of the hand grasp upon the grip or the tool angle relative to the grip. Foreseeable embodiments of this design include left-handed, right-handed and ambidextrous models. Other embodiments may include an outer layer of moldable gel material for added user comfort, or more rounded/narrower grips from front to rear surfaces for accurate hand sizing.

Lighting (6) comprises an energy source, housing (14) and light emitting source (16). Lead-acid or alkaline batteries provide an ample energy source. A preferable energy source is rechargeable batteries. In this embodiment, a photo voltaic array (PVA) may attach at various grip locations for self contained charging or to a unit for linked recharging. A recharger would draw from various power supplies including 12, 24, 48 or 220 volt direct current or 120 volt alternating current whether a PVA embodiment exists.

The device housing places the light source (16) superior, and at an acute angle, to the axis of the instrument secured, whether using an integral, external or user supplied light source. Typically, for example, the tool lies at about 20-35 degrees relative to the longitudinal axis of the light and light source, to place the tool tip farther out in front of the light for a larger diameter lighted area, or at about 35-50 degrees to place the tool tip closer to the light source for a smaller diameter light area.

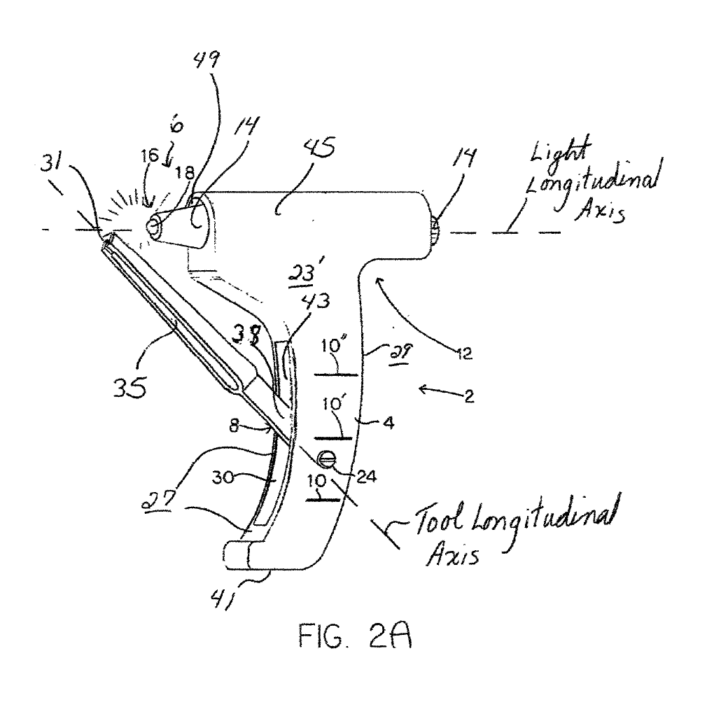

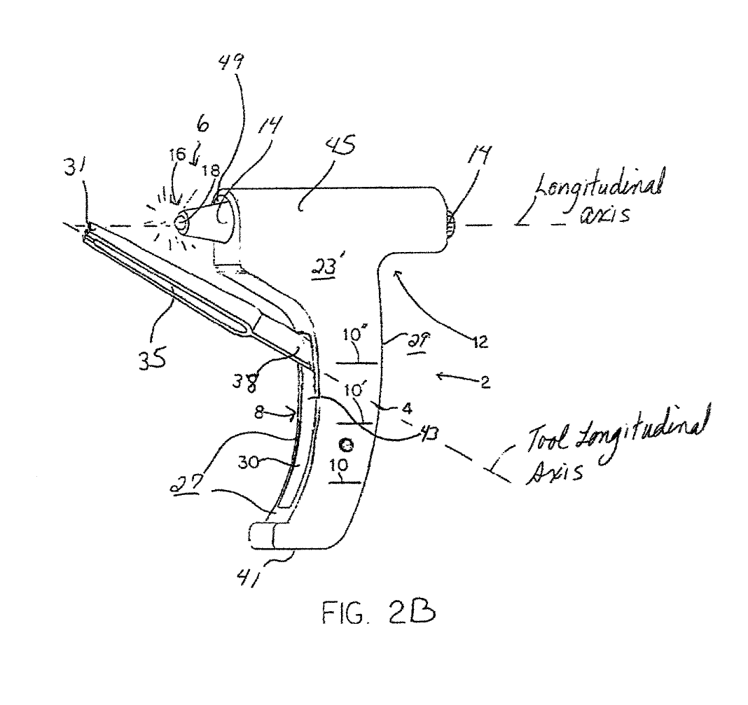

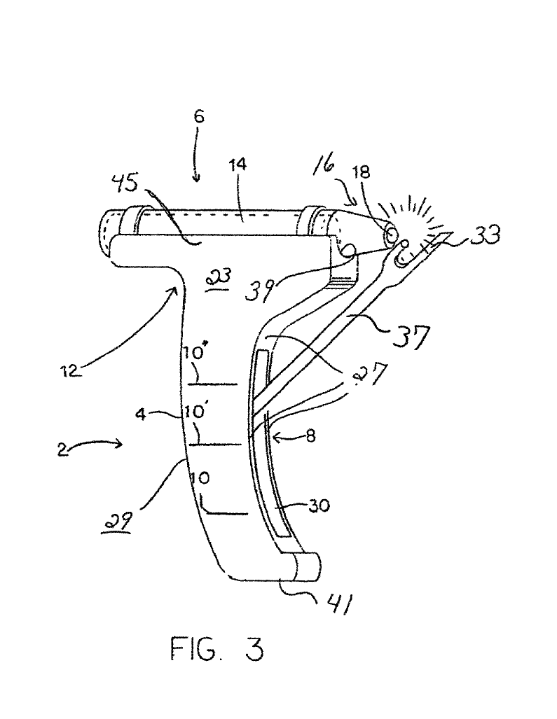

The light source (16) is positioned forward of the grip front surface (27) and directly above the working tip of the tool, or, more preferably, directly behind the tip (31, 33), as shown by the tweezer (35) and seam ripper (37) placement in FIGS. 2A, 2B, and 3. Light, therefore, radiates substantially unobstructed by the tool and by the grip and at an effective intensity around the tip (31, 33), so that the area of skin, cloth, leather, wood, etc. being worked on and the tip (31, 33) are well illuminated. The tool preferably may be adjusted at the docking system to adjust the location of the tool tip relative to the light radiating from the light source. In most instances, the tool is placed in the docking system so that the tool tip is generally in line with the light source, that is, aligned with the longitudinal axis of the radiating light. Then, to adjust the effective area of illumination, the tool tip is preferably moved forward or backward relative to the light, so that the area of light around the tool tip is larger (less “focused”) or smaller (more “focused” or more intense), respectively. Thus, when a sliver is being removed, one may place the tweezer tip close to the light for very intense light, or, when a seam is being ripped, one may place the seam ripper farther in front of the light for a softer, larger area of light. For example, with conventional tweezers, when the docked end (38) of the tweezer is slid or otherwise moved down in the docking system and the tweezer is slanted inward toward the grip, or at about 35-50 degrees to the longitudinal axis of the light, the tool tip is closer to the light source for an intense, smaller diameter lighted area. When the docked end 38 is slid or otherwise moved up in the docking system, and the tweezer is slanted further outward, the tool may rest roughly at 15-25 degrees relative to the longitudinal axis of the light and light source, which places the tool tip farther forward from the light for a larger diameter lighted working area. Such an adjustment of a tool in the docking system is illustrated in FIGS. 2A and 2B, wherein the tool tip is near the light bulb in FIG. 2A and farther out in FIG. 2B.

Housing for the illumination circuit may exist in several forms: A preferred method utilizes a flashlight configuration capable of holding two 1.5 volt batteries, or similar low voltage power sources, with a switch at a rearward location relative to the light source. Other embodiments include means to clamp the user's already purchased flashlight in a retrofit application. In these, and equivalent, embodiments the housing could be located internal or external to grip.

A preferred light bulb (18) is the Ray-Q-Vac (TM) RF22 for its even illumination band. Other light bulbs, fiber optic emitters, light emitting diodes (LEDs) or lasers are easily substituted. One preferred light source uses the RF22 in a red or blue-green spectrum to avoid the “night vision” loss associated with white light in dark environs.

Instrument docking system (8) may comprise many distinct embodiments including: one or more recesses with, or without, threading for a set screw (24), one or more bores at a location near the palm wherein instruments pass through the grip for affixation, a sliding clamp affixed to the grip distal to the user's palm to grasp desired implement(s), a slot (30) from the distal portion of the grip to a superior location below the light source, or a ball and socket apparatus that slides along the grip permitting snap in attachment or removal. The preferred docking system, as well as the grip, are narrow enough from side to side and from front surface to back surface so that the thumb and fingers curve comfortably and easily around them for manipulation of the tool.

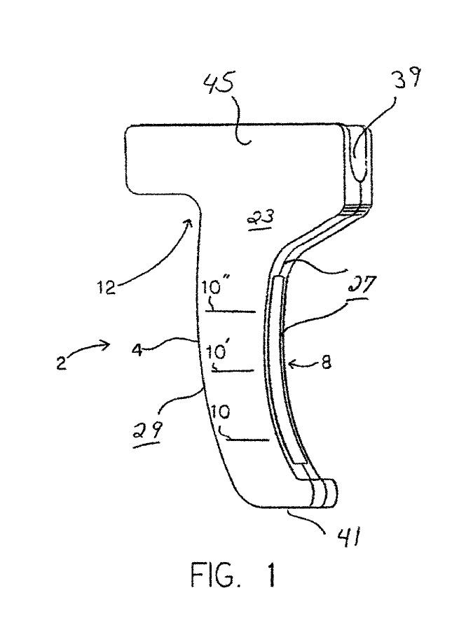

A simple example of the device could easily be whittled from wood according to the grip shapes shown in FIGS. 1-3. This grip has a slot (30) along the medial portion of the vertical axis extending from the base (41) of the device upwards to a medial location (43) that accepts hand-held instruments and holds them in place using frictional forces or, optionally, with an additional fastener, such as screw (24). Along the upper portion (45) of the grip a groove (39) or a bore (49) can be carved to rest a penlight or flashlight that secures to the grip using tape, hook-and-loop material, other fasteners, or friction. Thus, the preferred device holds the illumination means generally perpendicular to the length, that is, the vertical axis, of the grip. The light location relative to the grip may be fixed during manufacture and the instrument in the docking system made adjustable, as described above, to allow linear movement of the tool tip relative to the grip and the light. Alternative embodiments are envisioned wherein the light adjusts forward/backward and/or up and down relative to the grip. In any case, the light source preferably is within about 0.5-2.5 inches of the tool tip, generally directly behind the tip. The user completes the circuit for the illumination means and proceeds to utilize its instrument of choice with the benefit of an unobstructed self-supported light source. More refined examples may use injection molding, stamping or cast construction with a preference for non-conducting materials to eliminate the potential for electric shock.

Discussion of this invention referenced particular means, materials and embodiments elaborating limited application of the claimed invention. The invention is not limited to these particulars and applies to all equivalents.

What I claim as my invention is:

1. An instrument holder providing an illumination source, comprising:
(a) A pistol shaped “grip” designed to ergonomically rest in the user's hand.
(b) Illumination means at the superior portion of the grip and a multi-position docking mechanism.

2. The instrument holder of claim 1 wherein the light source is positioned forward of the front grip and above the tip of the instrument providing light to the working area without obstruction of said light by the instrument.

3. The instrument holder of claim 1 wherein the multi-position docking mechanism provides a 15-60 degrees positioning, of a wide range of instruments, to the longitudinal axis of the light source.
